(19) United States
(12) Patent Application Publication
(10) Pub. No.: US 2026/0230962 A1
(43) Pub. Date: Aug. 6, 2026

(54) NETWORK DEVICES, TERMINAL DEVICE AND METHODS FOR COMMUNICATIONS

(71) Applicant: LENOVO (BEIJING) LIMITED, Beijing (CN)

(72) Inventors: Mingzeng DAI, Beijing (CN); Joachim LÕHR, Wiesbaden (DE); Xiaoying XU, Beijing (CN); Haiyan LUO, Beijing (CN)

(21) Appl. No.: 19/159,083

(22) PCT Filed: Feb. 24, 2023
(86) PCT No.: PCT/CN2023/078263

§ 371 Date: Aug. 22, 2025

(51) Int. Cl. H04W 36/02

(52) U.S. Cl. CPC H04W 36/0235

(57) ABSTRACT

Embodiments of the present disclosure relate to a solution for communications. In one aspect of the solution, a first network device receives, from a third network device, at least one data packet in a set of data packets. Then, the first network device forwards, to a second network device, a subset of the at least one data packet. In turn, the first network device transmits, to the second network device, information about a transmission status of the set of data packets from the first network device to a terminal device. In turn, the second network device transmits, to the terminal device, at least one data packet in the subset based on the information about the transmission status.

### FIELD

Embodiments of the present disclosure generally relate to the field of communication, and in particular to network devices, terminal device and methods for communications.

### BACKGROUND

In some scenarios, a terminal device may need all data packets in a set of data packets to operate. For example, an application layer of the terminal device may need all the data packets to use the set of data packets. For another example, the terminal device may enter a Discontinuous Reception (DRX) sleep mode after receiving all the data packets in the set. Thus, in case of data forwarding due to handover or change in a bearer type, a network device receiving forwarded data needs to know whether transmission of the set of data packets to the terminal device is complete.

### SUMMARY

In general, embodiments of the present disclosure provide a solution for communications.

In a first aspect, there is provided a first network device. The first network device comprises a processor and a transceiver coupled to the processor. The processor is configured to: receive, via the transceiver, from a third network device, at least one data packet in a set of data packets; forward, via the transceiver to a second network device, a subset of the at least one data packet; and transmit, via the transceiver to the second network device information about a transmission status of the set of data packets from the first network device to a terminal device.

In a second aspect, there is provided a second network device. The second network device comprises a processor and a transceiver coupled to the processor. The processor is configured to: receive, via the transceiver from a first network device, a subset of a set of data packets; receive, from the first network device, information about a transmission status of the set of data packets from the first network device to a terminal device; and transmit, via the transceiver to the terminal device, at least one data packet in the subset based on the information about the transmission status.

In a third aspect, there is provided a terminal device. The terminal device comprises a processor and a transceiver coupled to the processor. The processor is configured to: determine a receiving status of a set of data packets; and transmit, via the transceiver to a second network device, an indication of the receiving status of the set of data packets.

In a fourth aspect, there is provided a method performed by a first network device. The method comprises: receiving, from a third network device, at least one data packet in a set of data packets; forwarding, to a second network device, a subset of the at least one data packet; and transmitting, to the second network device information about a transmission status of the set of data packets from the first network device to a terminal device.

In a fifth aspect, there is provided a method performed by a second network device. The method comprises: receiving, from a first network device, a subset of a set of data packets; receiving, from the first network device, information about a transmission status of the set of data packets from the first network device to a terminal device; and transmitting, to the terminal device, at least one data packet in the subset based on the information about the transmission status.

In a sixth aspect, there is provided a method performed by a terminal device. The method comprises: determining a receiving status of a set of data packets; and transmitting, to a second network device, an indication of the receiving status of the set of data packets.

In a seventh aspect, there is provided a computer readable medium. The computer readable medium has instructions stored thereon. The instructions, when executed on at least one processor of a device, causing the device to perform the method of the fourth or fifth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings in which:

FIGS. 1A and 1B illustrate an example of downlink data transmission, respectively;

FIG. 2 illustrates a schematic diagram of a communication environment in which some embodiments of the present disclosure can be implemented;

FIG. 3 illustrates a signaling chart illustrating an example process for communications in accordance with some embodiments of the present disclosure;

FIGS. 4 to 8 illustrate a signaling chart illustrating an example implementation of an example process for communications in accordance with some embodiments of the present disclosure, respectively;

FIG. 9 illustrates a flowchart of a method implemented at a network device in accordance with some embodiments of the present disclosure;

FIG. 10 illustrates a flowchart of a method implemented at a network device in accordance with other embodiments of the present disclosure;

FIG. 11 illustrates a flowchart of a method implemented at a terminal device in accordance with some embodiments of the present disclosure; and

FIG. 12 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms. In some examples, values, procedures, or apparatuses are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

The terminology used herein is for the purpose of describing particular embodiments only and is not intended to be limiting of embodiments. As used herein, the singular forms “a,” “an” and “the” are intended to include the plural forms as well, unless the context clearly indicates otherwise. It will be further understood that the terms “comprises,” “comprising,” “has,” “having,” “includes” and/or “including,” when used herein, specify the presence of stated features, elements, components and/or the like, but do not preclude the presence or addition of one or more other features, elements, components and/or combinations thereof. For example, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The use of an expression such as “A and/or B” can mean either “only A” or “only B” or “both A and B.” Other definitions, explicit and implicit, may be included below.

As used herein, the term “communication network” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VoIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

Extended Reality (XR), including Augmented Reality (AR) and Virtual Reality (VR), as well as Cloud Gaming (CG), presents a new promising category of connected devices, applications, and services. A Protocol Data Unit (PDU) Set and Quality of Service (QoS) characteristics of the PDU Set may be introduced for XR service.

In some embodiments, a PDU Set may comprise one or more PDUs carrying a payload of one unit of information generated at an application level. For example, the unit of information may be a frame or video slice for XR Services. In some implementations, all PDUs in a PDU Set are needed by the application layer to use the corresponding unit of information. In other implementations, the application layer can still recover part or all of the information unit when some PDUs in the PDU Set are missing.

To support PDU Set based QoS handling, a User Plane Function (UPF) may identify PDUs that belong to a PDU Set, determine PDU Set Information and send the PDU Set Information to a gNB in a General Packet Radio Service (GPRS) Tunnel Protocol-User Plane (GTP-U) header (which also includes GTP-U extension header). The PDU Set information may be used by the gNB for PDU Set handling.

In some embodiments, the PDU Set Information may comprise at least one of the following:
PDU Set Sequence Number,
Indication of End PDU of a PDU Set,
PDU Sequence Number within a PDU Set,
PDU Set Size in bytes, or
PDU Set Importance which identifies the importance of a PDU Set within a QoS Flow.

In some embodiments, the UPF may transmit a PDU Set QoS parameter called “PDU Set Integrated Handling Indication” (PSIHI) to the gNB. The PSIHI indicates that whether all PDUs are needed for the usage of a PDU Set by the application layer in the receiver side.

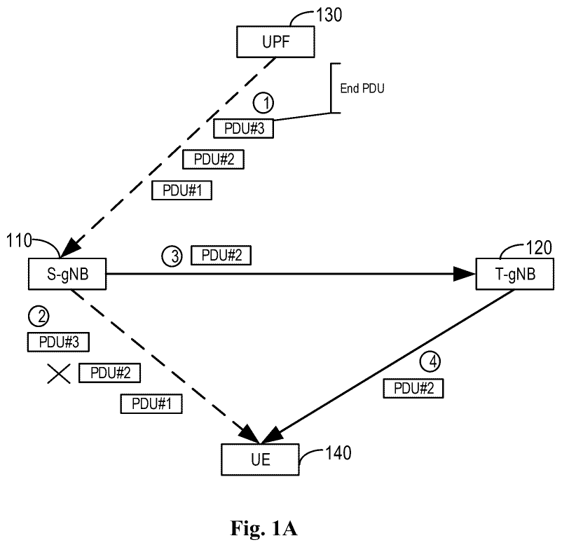

To support PDU Set based QoS handling, an Indication of End PDU of the PDU Set is provided by the UPF to the gNB in the GTP-U header. The Indication of End PDU of the PDU Set indicates the complete transmission of the PDU Set which is used for PDU Set integration handling. In order to support lossless handover, data forwarding from a source gNB to a target gNB is performed. In case of data forwarding is performed from the source gNB to the target gNB, how the target gNB knows the complete transmission of a PDU Set needs to be solved. This will be described with reference to FIGS. 1A and 1B.

FIGS. 1A and 1B illustrate an example of downlink data transmission, respectively. As shown in FIG. 1A, at step 1, a source gNB (S-gNB) 110 receives PDUs #1, #2 and #3 in a PDU Set from a UPF 130. The PDU #3 is an End PDU of the PDU Set.

At step 2, before handover, the source gNB 110 transmits the PDUs #1, #2 and #3 to a UE 140. The PDUs #1 and #3 have been transmitted to the UE 140 successfully while the PDU #2 before the PDU #3 (i.e., the End PDU) has not been acknowledged by the UE 140.

At step 3, the source gNB forwards the PDU #2 to a target gNB (T-gNB) 120 during data forwarding.

At step 4, the target gNB 120 transmits the PDU #2 to the UE 140.

Since the End PDU is not forwarded to the target gNB 120, the target gNB 120 does not know whether the transmission of the PDU Set is complete and thus is not able to perform PDU Set integrated handling for the PDU Set.

As shown in FIG. 1B, at step 1, the source gNB 110 receives the PDUs #1 and #2 in the PDU Set as well as an end marker (EM) packet from the UPF 130. The source gNB 110 does not receive the End PDU in the PDU Set from the UPF 130.

At step 2, before handover, the source gNB 110 transmits the PDUs #1 and #2 to the UE 140. The PDU #1 has been transmitted to the UE 140 successfully while the PDU #2 has not been acknowledged by the UE 140.

At step 3, the source gNB forwards the PDU #2 and the EM packet to the target gNB 120 during data forwarding.

At step 4, the UPF 130 may transmit the End PDU to the target gNB 120.

However, the target gNB 120 does not know whether the End PDU is expected to be received from the UPF 130 for the PDU Set and thus is not able to perform PDU Set integration handling for the PDU Set before receiving the End PDU.

In addition to the examples of FIGS. 1A and 1B, in a scenario where a data burst is transmitted, in case of data forwarding, a network device receiving the forwarded data also needs to know whether transmission of the data burst to a terminal device is complete.

Take Master Node (MN) terminated split bearer in NR dual connectivity (NR-DC) as an example. The MN receives an indication of end of a data burst from UPF. The MN may send the PDU with the indication of end of the data burst via Master Cell Group (MCG) leg to the terminal device. But the Secondary Node (SN) still needs to be aware of the complete transmission of the data burst for power saving purpose, for example, cause the terminal device to enter a DRX sleep mode regarding the DRX group with Secondary Cell Group (SCG).

In view of the above, embodiments of the present disclosure provide a solution for communications. In this solution, a first network device receives, from a third network device, at least one data packet in a set of data packets. Then, the first network device forwards, to a second network device, a subset of the at least one data packet. In turn, the first network device transmits, to the second network device, information about a transmission status of the set of data packets from the first network device to a terminal device. Based on the information about the transmission status, the second network device may determine whether transmission of the set of data packets to the terminal device is complete. In turn, the second network device transmits, to the terminal device, at least one data packet in the subset based on the information about the transmission status. In this way, this solution may ensure that all the data packets in the set are received by the terminal device. Then, the terminal device may operate based on the set of data packets.

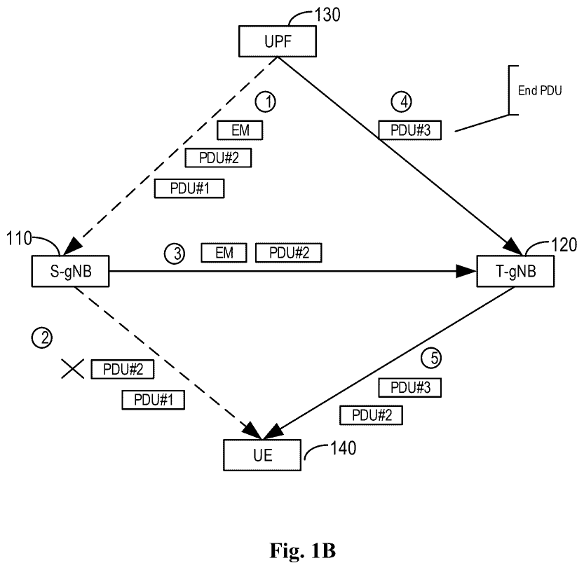

Hereinafter, principle of the present disclosure will be described with reference to FIGS. 2 to 12.

FIG. 2 illustrates a schematic diagram of a communication environment 200 in which some embodiments of the present disclosure can be implemented. The environment 200 may comprise a first network device 210, a second network device 220, a third network device 230, a fourth network device 240, and a terminal device 250.

In some embodiments, each of the first network device 210 and the second network device 220 may be implemented as a network device in a radio access network, such as a gNB. In such embodiments, the first network device 210 may communicate with the second network device 220 via an Xn interface between them.

In some embodiments, each of the third network device 230 and the fourth network device 240 may be implemented as a network device in a core network. For example, the third network device 230 may be implemented as a UPF and the fourth network device 240 may be implemented as an Access and Mobility management Function (AMF). In such embodiments, the third network device 230 may communicate with the fourth network device 240 via a Session Management Function (SMF, not shown).

In some embodiments, the third network device 230 may communicate with each of the first network device 210 and the second network device 220 via a corresponding Next Generation User Plane (NG-U) interface. The fourth network device 240 may communicate with each of the first network device 210 and the second network device 220 via a corresponding Next Generation Control Plane (NG-C) interface.

In some embodiments, the terminal device 250 may perform handover from the first network device 210 to the second network device 220. In such embodiments, the first network device 210 may be referred to as a source network device, and the second network device 220 may be referred to as a target network device.

In some embodiments, the terminal device 250 may operate in a dual connectivity (DC) mode. In the DC mode, the terminal device 250 may communicate with the first network device 210 to the second network device 220 simultaneously. In such embodiments, one of the first network device 210 to the second network device 220 may be implemented as a Packet Data Convergence Protocol (PDCP) terminated node of a bearer, and the other may be implemented as a peer node. For example, one of the first network device 210 to the second network device 220 may be implemented as a Master Node (MN) and the other may be implemented as a Secondary Node (SN).

The first network device 210 receives, from the third network device 230, at least one data packet in a set of data packets. Then, the first network device 210 forwards, to the second network device 220, a subset of the at least one data packet. The first network device 210 transmits, to the second network device 220, information about a transmission status of a set of data packets from the first network device 210 to the terminal device 250. Based on the information about the transmission status, the second network device 220 transmits, to the terminal device, at least one data packet in the subset. In this way, this solution may ensure that all the data packets in the set are received by the terminal device. Then, the terminal device may operate based on the set of data packets.

It is to be understood that the numbers of the network devices and terminal devices are only for ease of understanding without suggesting any limitations. The communication environment 200 may include any suitable number or type of the network devices and terminal devices adapted for implementing embodiments of the present disclosure.

Communications in the communication environment 200 may be implemented according to any proper communication protocol(s), comprising, but not limited to, cellular communication protocols of the first generation (1G), the second generation (2G), the third generation (3G), the fourth generation (4G), the fifth generation (5G) or the future sixth generation (6G) wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

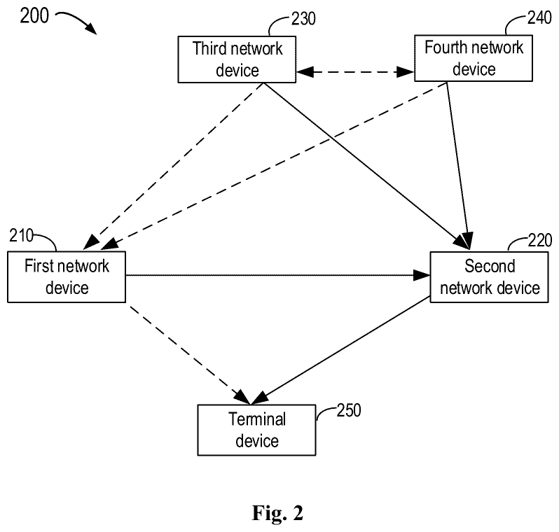

FIG. 3 illustrates a signaling chart illustrating an example process 300 for communications in accordance with some embodiments of the present disclosure. For the purpose of discussion, the process 300 will be described with reference to FIG. 2. The process 300 may involve the first network device 210, the second network device 220, the third network device 230 and the terminal device 250.

As shown in FIG. 3, the first network device 210 receives 310, from the third network device 230, at least one data packet in a set of data packets.

In some embodiments, the set of data packets may comprise a PDU Set. In some embodiments, the PDU Set may comprise one or more PDUs carrying a payload of one unit of information generated at an application level. For example, the unit of information may be a frame or video slice for XR Services.

Alternatively, in some embodiments, the set of data packets may comprise a data burst. The data burst may comprise multiple PDUs generated and sent by an application in a short period of time. The data burst may comprise one or more PDU Sets.

Then, the first network device 210 forwards 320, to the second network device 220, a subset of the at least one data packet.

In some embodiments, the subset of the at least one data packet may comprise all or part of data packets received from the third network device 230.

In turn, the first network device 210 transmits 330, to the second network device 220, information about a transmission status of a set of data packets from the first network device 210 to the terminal device 250.

Based on the information about the transmission status, the second network device 220 transmits 340, to the terminal device 250, at least one data packet in the subset.

The process 300 may ensure that all the data packets in the set are received by the terminal device 250. Then, the terminal device 250 may operate based on the set of data packets.

It shall be noted that although the action 330 is shown after the action 320, the action 330 may be performed in parallel to the action 320 or prior to the action 320.

In some embodiments, the information about the transmission status may comprise an indication of a last data packet that has not been transmitted to the terminal device 250 successfully by the first network device 210.

In some embodiments, the first network device 210 may have transmitted a data packet to the terminal device 250 but has not received positive acknowledgement from the terminal device 250. In such embodiments, the data packet may be referred to as a data packet that has not been transmitted to the terminal device 250 successfully by the first network device 210.

Alternatively, in some embodiments, the first network device 210 may have received a data packet from the third network device 230 but has not transmitted it to the terminal device 250. In such embodiments, the data packet may be also referred to as a data packet that has not been transmitted to the terminal device 250 successfully by the first network device 210.

Hereinafter, for brevity, “a data packet that has not been transmitted to the terminal device 250 successfully by the first network device 210” is also referred to as “a data packet that has not been transmitted successfully”.

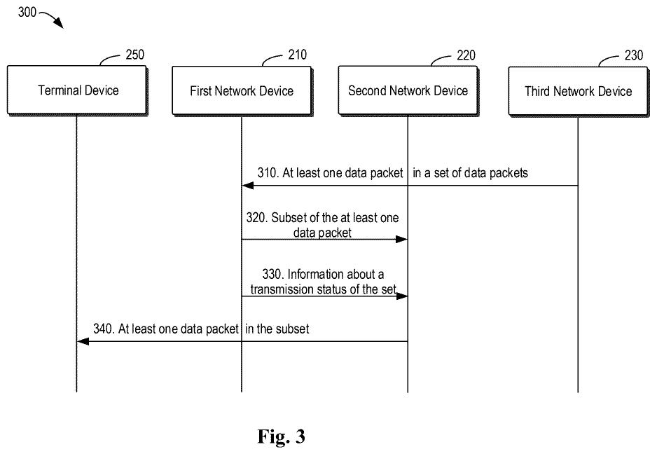

In some embodiments, the indication of the last data packet that has not been transmitted successfully may comprise an ending indication for the set of data packets. This will be described with reference to FIG. 4.

FIG. 4 illustrates a signaling chart illustrating an example process 400 for communications in accordance with some embodiments of the present disclosure. The process 400 may be considered an example implementation of the process 300. For the purpose of discussion, the process 400 will be described with reference to FIG. 2. The process 400 may involve the first network device 210, the second network device 220, the third network device 230, the fourth network device 240 and the terminal device 250. The process 400 may be described by taking a PDU Set as an example of the set of data packets.

As shown in FIG. 4, a PDU Set comprises PDU #1, PDU #2, PDU #3 and PDU #4. The first network device 210 receives 410, from the third network device 230, PDU #1, PDU #2, PDU #3 and PDU #4 in the PDU Set. PDU #4 is an End PDU in the PDU Set. A GTP-U extension header of PDCP Service Data Unit (SDU) associated with PDU #4 may comprise an indication of End PDU which indicates that PDU #4 is the last PDU in the PDU Set.

In addition, the first network device 210 also receives an EM packet from the third network device 230. The EM packet is used to mark the last packet transmitted from the third network device 230 to the first network device 210 before path switch.

The first network device 210 transmits 415, to the terminal device 250, PDU #1 and PDU #4 successfully. In other words, the first network device 210 has transmitted PDU #1 and PDU #4 to the terminal device 250 and received positive acknowledgement from the terminal device 250.

However, the first network device 210 has transmitted PDU #2 and PDU #3 to the terminal device 250 but has not received positive acknowledgement from the terminal device 250. In other words, PDU #2 and PDU #3 have not been transmitted to the terminal device 250 successfully by the first network device 210.

In response to trigger of a handover procedure, the first network device 210 transmits 420 a Handover Request message to the second network device 220. Upon receiving the Handover Request message, the second network device 220 transmits 425 a Handover Request Acknowledgement (Ack) message to first network device 210.

Upon receiving the Handover Request Ack message, the first network device 210 transmits 430 a Radio Resource Control (RRC) Reconfiguration message (with synchronization) to the terminal device 250. In addition, the first network device 210 transmits 435 an Sequence Number (SN) Status Transfer message to the second network device 220.

Upon receiving the RRC Reconfiguration message, the terminal device 250 transmits 440 an RRC Reconfiguration Complete message to the second network device 220.

Upon receiving the RRC Reconfiguration Complete message, the second network device 220 transmits 445 a Path Switch Request message to the fourth network device 240. In response, the fourth network device 240 transmits 450 a Path Switch Request Ack message to the second network device 220.

In order to support lossless handover, the first network device 210 may perform Data Radio Bearer (DRB) based data forwarding to the second network device 220. For example, the first network device 210 forwards 455, to the second network device 220, PDU #2 and PDU #3 as well as the EM packet. PDU #2 and PDU #3 are PDUs that have not been transmitted to the terminal device 250 successfully by the first network device 210. In particular, PDU #3 is a last PDU that has not been transmitted to the terminal device 250 successfully by the first network device 210.

In order to transmit information about a transmission status of the PDU Set, the first network device 210 adds, in PDU #3, an ending indication for the PDU Set. The ending indication for the PDU Set may indicate that PDU #3 is the last PDU that has not been transmitted successfully for the PDU set.

For example, a GTP-U extension header of PDCP SDU associated with PDU #3 may comprise the ending indication for the PDU Set. For example, the GTP-U extension header may comprise a PDCP SN GTP-U extension header or a PDU session container GTP-U extension header.

It shall be noted that the meaning of the “ending indication for the PDU Set” may be different from that of the “Indication of End PDU in the PDU Set”. As described above, “the ending indication for the PDU Set” may indicate the last PDU that has not been transmitted successfully while the “Indication of End PDU in the PDU Set” indicates the complete transmission of the PDU Set. The complete transmission of the PDU Set is used for PDU Set integrated handling. In this regard, a PDU comprising the “ending indication for the PDU Set” may be different from the End PDU comprising the “Indication of End PDU in the PDU Set”.

For example, in the example process 400, the PDU comprising the “ending indication for the PDU Set” is PDU #3 and PDU #3 is the last PDU that has not been transmitted successfully. The End PDU comprising the “Indication of End PDU in the PDU Set” is PDU #4 and PDU #4 has been transmitted successfully.

For another example, before the path switch, the first network device 210 may have not received the End PDU from the third network device 230. Thus, after the path switch, the second network device 220 will receive the End PDU from the third network device 230. In this example, a PDU comprising the “ending indication for the PDU Set” is different from the End PDU comprising the “Indication of End PDU in the PDU Set”.

In some embodiments, to distinguish from the “Indication of End PDU in the PDU Set”, the “ending indication for the PDU Set” may be referred to as a “temporal ending indication for the PDU Set” or a “hypothetical ending indication for the PDU Set”.

With continued reference to FIG. 4, upon receiving PDU #2 and PDU #3 which comprises the ending indication for the PDU Set, the second network device 220 determines that PDU #2 and PDU #3 are PDUs that has not been transmitted successfully. In addition, the second network device 220 determines 460 that PDU #3 is the last PDU that has not been transmitted to the terminal device 250 successfully by the first network device 210. In turn, the second network device 220 transmits 465 PDU #2 and PDU #3 to the terminal device 250.

In this way, the second network device 220 may ensure that all the PDUs in the PDU Set are received by the terminal device 250. Then, the terminal device 250 may operate based on the PDU Set.

In other embodiments, the indication of the last data packet that has not been transmitted successfully may an implicit indication. For example, the indication of the last data packet that has not been transmitted successfully may comprise a last sequence number (SN) for the last data packet. The last SN is higher than SNs for other data packets in the subset. In other words, the last SN is the highest one among SNs for the data packets in the subset.

In such embodiments, the first network device 210 may continue to allocate PDCP SNs for PDUs in a PDU Set received from the third network device 230 if any of the PDUs has been sent to the terminal device 250. The first network device 210 may put the PDCP SNs in GTP-U extension headers of PDCP SDUs associated with the PDUs when forwarding the PDUs to the second network device 220.

For example, the second network device 220 may identify PDUs belonging to a PDU Set by PDU Set sequence number in the GTP-U header. The second network device 220 may determine that a PDU with the highest PDCP SN among the PDUs forwarded by the first network device 210 to be the last data packet that has not been transmitted successfully.

The process 400 has been described by taking a PDU Set as an example of the set of data packets. Alternatively, in some embodiments, the set of data packets may comprise a data burst. The data burst may comprise one or more PDU Sets. The process 400 may be applicable to the embodiments where the set of data packets may comprise a data burst.

In embodiments where MN terminated split bearer is used in case of NR-DC, the first network device 210 may be implemented as MN and the second network device 220 may be implemented as SN.

In such embodiments, the indication of the last data packet may comprise an ending indication for the data burst. The ending indication for the data burst may indicate that PDU #3 is the last PDU in the data burst to be transmitted in SCG.

The first network device 210 may add the ending indication for the data burst in Use Plane protocol such as GTP-U extension header. For example, one new bit may be added in a DL USER DATA frame for the ending indication.

The first network device 210 may transmit the ending indication for the data burst in the GTP-U extension header of the last forwarded PDCP PDU or after the last forwarded PDCP PDU.

In embodiments where SN terminated split bearer is used in case of NR-DC, the first network device 210 may be implemented as SN and the second network device 220 may be implemented as MN. In such embodiments, the ending indication for the data burst may indicate that PDU #3 is the last PDU in the data burst to be transmitted in MCG.

In some embodiments, the subset forwarded by the first network device 210 may comprise an end data packet in the set of data packets, and the information about the transmission status may comprise an indication of the end data packet.

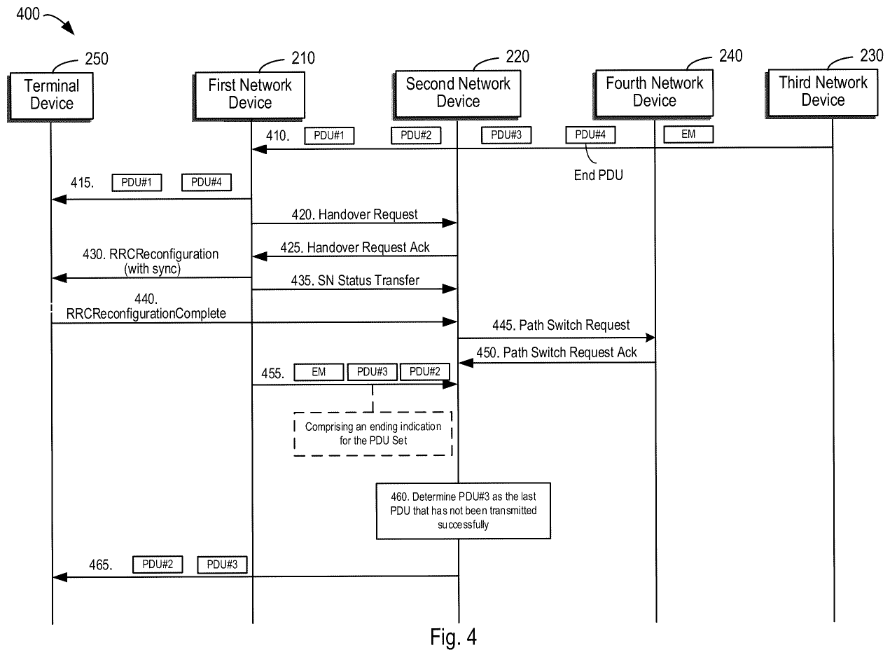

For example, in embodiments where the set of data packets comprises a PDU Set, the end data packet in the set of data packets may be an End PDU in the PDU Set, and the information about the transmission status may comprise an indication of End PDU. This will be described with reference to FIG. 5.

FIG. 5 illustrates a signaling chart illustrating an example process 500 for communications in accordance with some embodiments of the present disclosure. The process 500 may be considered an example implementation of the process 300. For the purpose of discussion, the process 500 will be described with reference to FIG. 2. The process 500 may involve the first network device 210, the second network device 220, the third network device 230, the fourth network device 240 and the terminal device 250. The process 500 may be described by taking a PDU Set as an example of the set of data packets.

Actions 410, 415, 420, 425, 430, 435, 440, 445 and 450 in the process 500 are the same as those in the process 400. Thus, details of these actions are omitted for brevity.

Actions 555, 560 and 565 in the process 500 are different from actions 455, 460 and 465 in the process 400.

Specifically, during data forwarding, in addition to PDU #2, PDU #3 and the EM packet, the first network device 210 also forwards 555 PDU #4 to the second network device 220. PDU #4 is the End PDU in the PDU Set which has been transmitted to the terminal device 250 successfully.

The indication of End PDU (i.e., PDU #4) may have been removed by the Service Data Adaptation Protocol (SDAP) layer of the first network device 210. In order to transmit information about the transmission status of the PDU Set, the first network device 210 re-adds the indication of End PDU in the GTP-U extension header of the PDCP SDU associated with PDU #4. For example, the first network device 210 may re-add the indication of End PDU in a PDCP SN GTP-U extension header or PDU session container GTP-U extension header of the PDCP SDU associated with PDU #4.

Upon receiving PDU #4 which comprises the indication of End PDU, the second network device 220 determines 560 that PDU #4 is the last PDU in the PDU Set. In turn, the second network device 220 may transmit 565 PDU #2, PDU #3 and PDU #4 to the terminal device 250.

In this way, the second network device 220 may ensure that all the PDUs in the PDU Set are received by the terminal device 250. Then, the terminal device 250 may operate based on the PDU Set.

In other embodiments, the second network device 220 may receive, from the terminal device 250, an indication of receiving statuses of PDUs in the PDU Set. The second network device 220 may transmit, to the terminal device 250, at least one of the PDUs received from the first network device 210 based on the indication of receiving statuses.

In some embodiments, the second network device 220 may receive the indication of receiving statuses via a PDCP Status Report (SR). The PDCP SR may comprise a PDU Set sequence number and PDU sequence number within the PDU Set. The PDCP SR may also comprise a bitmap to indicate whether each PDU in the PDU Set has been received successfully or not. If a bit in the bitmap indicates “true” or “yes”, it means a PDU in the PDU Set has been received successfully by the terminal device 250. Otherwise, it means the PDU has not been received (e.g. named as a missing PDU), and then the second network device 220 transmits the missing PDU in the PDU Set to the terminal device 250.

For example, if the PDCP SR indicates PDU #1 and PDU #4 (i.e., the End PDU) have been received successfully but PDU #2 and PDU #3 are missing, the second network device 220 may transmit PDU #2 and PDU #3 to the terminal device 250.

Alternatively, in some embodiments, the second network device 220 may receive, from the terminal device 250, an indication of a receiving status of the PDU Set. In turn, the second network device 220 may transmit, to the terminal device 250, at least one of the PDUs received from the first network device 210 based on the indication of the receiving status of the PDU Set.

In such embodiments, the second network device 220 may receive the indication of receiving statuses via a PDCP SR. The PDCP SR may comprise a PDU Set sequence number and a bit to indicate whether the PDU Set identified by the sequence number has been received successfully or not. If the bit indicates “true” or “yes”, it means all the PDUs in the PDU Set have been received successfully by the terminal device 250. Otherwise, it means there is still one or more PDUs in the PDU Set have not been received successfully. Then, the second network device 220 transmits all forwarded PDUs in the PDU Set received from the first network device 210 to the terminal device 250.

The process 500 has been described by taking a PDU Set as an example of the set of data packets. Alternatively, in some embodiments, the set of data packets may comprise a data burst. The data burst may comprise one or more PDU Sets. The process 500 may be applicable to the embodiments where the set of data packets may comprise a data burst.

In embodiments where MN terminated split bearer is used in case of NR-DC, the first network device 210 may be implemented as MN and the second network device 220 may be implemented as SN.

In such embodiments, the information about the transmission status may comprise an indication of an end data packet of the data burst. The indication of the end data packet of the data burst may indicate to the second network device 220 (SN) that the transmission of the data burst is complete in SCG.

In such embodiments, the first network device 210 may transmit the end data packet of the data burst comprising the indication to the second network device 220.

In embodiments where SN terminated split bearer is used, the first network device 210 may be implemented as SN and the second network device 220 may be implemented as MN. In such embodiments, the indication of the end data packet of the data burst may indicate to the second network device 220 (MN) that the transmission of the data burst is complete in MCG.

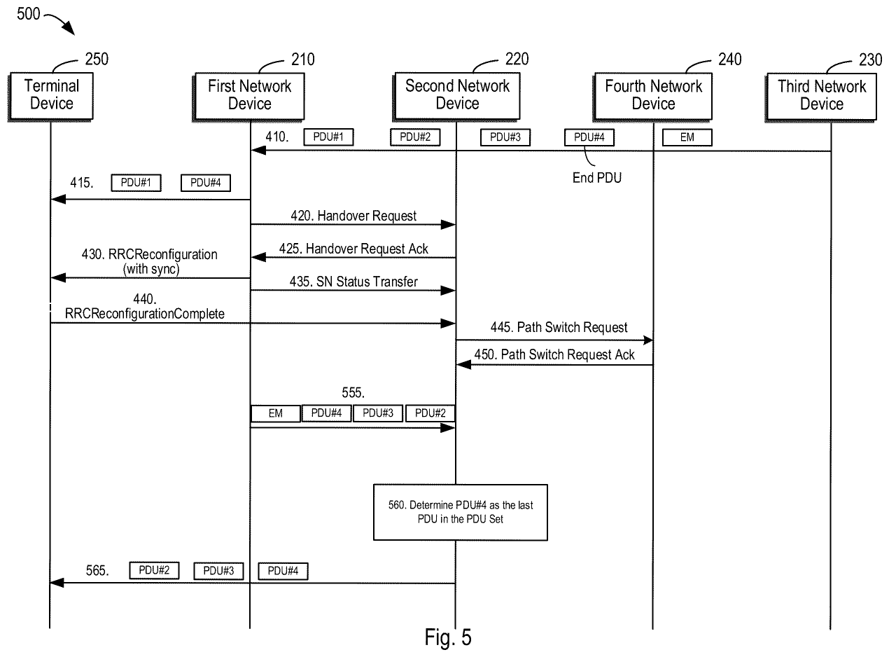

In some embodiments, the subset forwarded by the first network device 210 may comprise all the data packets in the set of data packets, and the information about the transmission status of the set of data packets may comprise an indication of an end data packet in the set of data packets. This will be described with reference to FIG. 6.

FIG. 6 illustrates a signaling chart illustrating an example process 600 for communications in accordance with some embodiments of the present disclosure. The process 600 may be considered an example implementation of the process 300. For the purpose of discussion, the process 600 will be described with reference to FIG. 2. The process 600 may involve the first network device 210, the second network device 220, the third network device 230, the fourth network device 240 and the terminal device 250. The process 600 may be described by taking a PDU Set as an example of the set of data packets.

Actions 410, 415, 420, 425, 430, 435, 440, 445 and 450 in the process 600 are the same as those in the process 400. An action 560 in the process 600 is the same as that in the process 500. Thus, details of these actions are omitted for brevity.

Actions 655 and 665 in the process 600 are different from actions 455 and 465 in the process 400 and different from actions 555 and 565 in the process 500.

Specifically, during data forwarding, in addition to PDU #2, PDU #3 and the EM packet, the first network device 210 also forwards 655 PDU #1 and PDU #4 to the second network device 220. PDU #4 is the End PDU in the PDU Set which has been transmitted to the terminal device 250 successfully.

In other words, the first network device 210 forwards all the PDUs in the PDU Set. In this case, PDU session level data forwarding could be performed, which means the PDU Set Information in the GTP-U header received from the third network device 230 are kept. The second network device 220 identifies the PDU Set by reading the GTP-U header. The indication of End PDU is also kept in the GTP-U header of the PDU #4.

Similar to the process 500, in the process 600, upon receiving PDU #4 which comprises the indication of End PDU, the second network device 220 determines 560 that PDU #4 is the last PDU in the PDU Set. In turn, the second network device 220 may transmit 665 PDU #1, PDU #2, PDU #3 and PDU #4 to the terminal device 250.

In this way, the second network device 220 may ensure that all the PDUs in the PDU Set are received by the terminal device 250. Then, the terminal device 250 may operate based on the PDU Set.

In other embodiments, similar to the process 500, in the process 600, the second network device 220 may receive, from the terminal device 250, an indication of receiving statuses of PDUs in the PDU Set. The second network device 220 may transmit, to the terminal device 250, at least one of the PDUs received from the first network device 210 based on the indication of receiving statuses. In such embodiments, the second network device 220 may receive the indication of receiving statuses via a PDCP SR. For example, if the PDCP SR indicates PDU #1 and PDU #4 (i.e., the End PDU) have been received successfully but PDU #2 and PDU #3 are missing, the second network device 220 may transmit PDU #2 and PDU #3 to the terminal device 250.

Alternatively, in some embodiments, the second network device 220 may receive, from the terminal device 250, an indication of a receiving status of the PDU Set. In turn, the second network device 220 may transmit, to the terminal device 250, at least one of the PDUs received from the first network device 210 based on the indication of the receiving status of the PDU Set.

In such embodiments, the second network device 220 may receive the indication of receiving statuses via a PDCP SR. The PDCP SR may comprise a PDU Set sequence number and a bit to indicate whether the PDU Set identified by the sequence number has been received successfully or not. If the bit indicates “true” or “yes”, it means all the PDUs in the PDU Set have been received successfully by the terminal device 250. Otherwise, it means there is still one or more PDUs in the PDU Set have not been received successfully. Then, the second network device 220 transmits all the PDUs in the PDU Set to the terminal device 250.

In some embodiments, the information about the transmission status of the set of data packets may comprise at least one of the following:
a first indication indicating whether the set of data packets has been transmitted to the terminal device 250 successfully by the first network device 210,
a second indication of transmission statuses of the data packets in the set, or
a third indication of a transmission status of an end data packet in the set.

In some embodiments, the third indication may comprise one of the following:
a fourth indication indicating whether the end data packet has been transmitted to the terminal device 250 successfully by the first network device 210,
a fifth indication indicating that the end data packet has been received from a third network device 230 but has not been transmitted to the terminal device 250 by the first network device 210, or
a sixth indication indicating that the end data packet has not been received from the third network device 230.

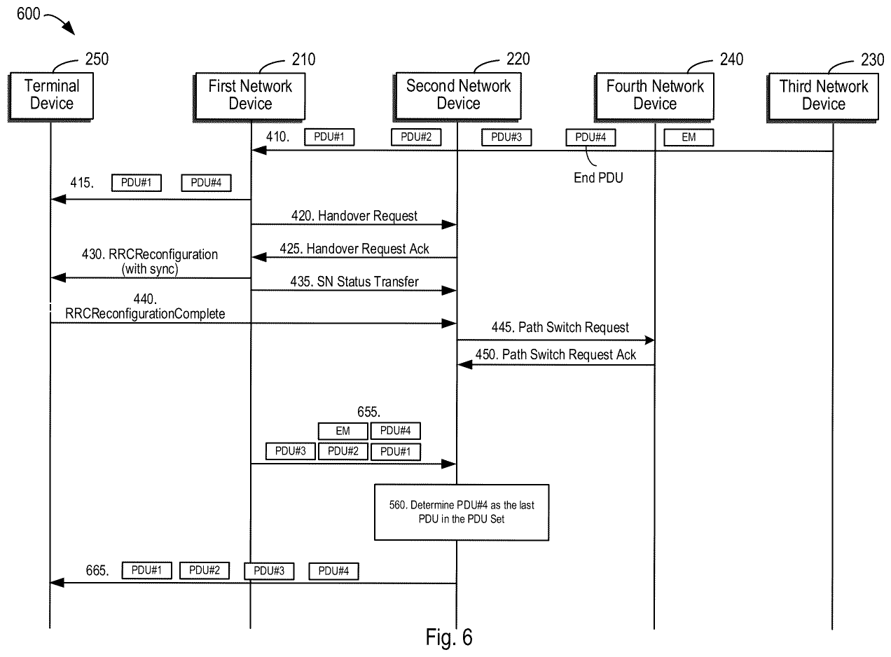

FIG. 7 illustrates a signaling chart illustrating an example process 700 for communications in accordance with some embodiments of the present disclosure. The process 700 may be considered an example implementation of the process 300. For the purpose of discussion, the process 700 will be described with reference to FIG. 2. The process 700 may involve the first network device 210, the second network device 220, the third network device 230, the fourth network device 240 and the terminal device 250. The process 700 may be described by taking a PDU Set as an example of the set of data packets.

Actions 410, 415, 420, 425, 430, 440, 445 and 450 in the process 700 are the same as those in the process 400. Thus, details of these actions are omitted for brevity.

Actions 735, 755, 760 and 765 in the process 700 are different from actions 435, 455, 460 and 465 in the process 400.

In the process 700, in order to transmit information about a transmission status of a PDU Set to the second network device 220, the first network device 210 transmits the first indication to the second network device 220 via a control signaling. The first indication indicates whether the PDU Set has been transmitted to the terminal device 250 successfully by the first network device 210.

The first network device 210 may transmit 735 an SN Status Transfer message to the second network device 220. The SN Status Transfer message may comprise the first indication. Alternatively, the first indication may be comprised in a control signaling which is different from the SN Status Transfer message.

In some embodiments, the first indication may comprise a PDU Set sequence number and a bit to indicate whether the PDU Set identified by the sequence number has been transmitted to the terminal device 250 successfully or not. If the bit indicates “true” or “yes”, it means all the PDUs in the PDU Set have been transmitted to the terminal device 250 successfully. Otherwise, it means there is still one or more PDUs of the PDU Set which have not been transmitted successfully. For example, in the process 700, the bit may indicate “false” or “no”, which means there is still one or more PDUs of the PDU Set which have not been transmitted successfully.

During data forwarding, the first network device 210 forwards 755 PDU #2 and PDU #3 to the second network device 220.

Based on the first indication and the received PDU #2 and PDU #3, the second network device 220 determines 760 PDU #2 and PDU #3 have not been transmitted successfully. In turn, the second network device 220 transmits 765 PDU #2 and PDU #3 to the terminal device 250. In this way, the second network device 220 may ensure that all the PDUs in the PDU Set are received by the terminal device 250.

Alternatively, in order to transmit information about a transmission status of a PDU Set to the second network device 220, the first network device 210 transmits, to the second network device 220 via a control signaling, the second indication of transmission statuses of PDUs in the PDU Set.

In some embodiments, the second indication may comprise the PDU Set sequence number, PDU sequence number within the PDU Set and a bitmap to indicate whether each PDU in the PDU Set has been transmitted to the terminal device 250 successfully or not. If a bit in the bitmap indicates ‘true’ or ‘yes’, it means that a PDU associated with the bit in the PDU Set has been transmitted to the terminal device 250 successfully. Otherwise, it means that the PDU has not been transmitted successfully. For example, in the process 700, the bits associated with PDU #2 and PDU #3 may indicate “false” or “no”, which means PDU #2 and PDU #3 have not been transmitted successfully.

The first network device 210 may transmit 735 the SN Status Transfer message to the second network device 220. The SN Status Transfer message may comprise the second indication. Alternatively, the second indication may be comprised in a control signaling which is different from the SN Status Transfer message.

Based on the second indication and the received PDU #2 and PDU #3, the second network device 220 determines 760 PDU #2 and PDU #3 have not been transmitted successfully. In turn, the second network device 220 transmits 765 PDU #2 and PDU #3 to the terminal device 250. In this way, the second network device 220 may ensure that all the PDUs in the PDU Set are received by the terminal device 250.

Alternatively, in order to transmit information about a transmission status of a PDU Set to the second network device 220, the first network device 210 may transmit, to the second network device 220 via a control signaling, the third indication of the transmission status of the End PDU in the PDU Set.

In some embodiments, the third indication of the transmission status of the End PDU may comprise one of the following:
a fourth indication indicating whether the End PDU has been transmitted to the terminal device 250 successfully by the first network device 210,
a fifth indication indicating that the End PDU has been received from the third network device 230 but has not been transmitted to the terminal device 250 by the first network device 210, or
a sixth indication indicating that the End PDU has not been received from the third network device 230.

In some embodiments, the third indication may comprise a PDU Set sequence number and the fourth indication. The fourth indication may comprise a bit to indicate whether an End PDU in the PDU Set identified by the sequence number has been transmitted to the terminal device 250 successfully. If the bit indicates “true” or “yes”, it means the End PDU has been transmitted to the terminal device 250 successfully. Otherwise, it means the End PDU has not been transmitted successfully. For example, in the process 700, the bit may indicate “true” or “yes”, which means the End PDU (i.e., PDU #4) has been transmitted to the terminal device 250 successfully.

During data forwarding, the first network device 210 forwards 755 PDU #2 and PDU #3 to the second network device 220.

Based on the received PDU #2 and PDU #3, the second network device 220 determines 760 PDU #2 and PDU #3 have not been transmitted successfully. Based on the third indication, the second network device 220 determines the End PDU (i.e., PDU #4) has been transmitted to the terminal device 250 successfully.

In turn, the second network device 220 transmits 765 PDU #2 and PDU #3 to the terminal device 250. In this way, the second network device 220 may ensure that all the PDUs in the PDU Set are received by the terminal device 250.

Alternatively, in order to transmit information about a transmission status of a PDU Set to the second network device 220, the first network device 210 may transmit, to the second network device 220 via a control signaling, both the first indication and the second indication.

For example, in the process 700, based on the first indication, the second network device 220 determines that PDU Set has not been transmitted to the terminal device 250 successfully. Based on the first indication and the second indication, the second network device 220 determines that only PDU #2 and PDU #3 in the PDU Set have not been transmitted to the terminal device 250 successfully. In turn, the second network device 220 transmits PDU #2 and PDU #3 to the terminal device 250.

Alternatively, in order to transmit information about a transmission status of a PDU Set to the second network device 220, the first network device 210 may transmit, to the second network device 220 via a control signaling, the first indication, the second indication and the third indication.

For example, in the process 700, based on the first indication, the second network device 220 determines that PDU Set has not been transmitted to the terminal device 250 successfully. Based on the second indication, the second network device 220 determines that PDU #2 and PDU #3 in the PDU Set have not been transmitted to the terminal device 250 successfully. Based on the third indication, the second network device 220 determines that the End PDU (i.e., PDU #4) in the PDU Set has been transmitted to the terminal device 250 successfully.

In turn, the second network device 220 transmits 765 PDU #2 and PDU #3 to the terminal device 250. In this way, the second network device 220 may ensure that all the PDUs in the PDU Set are received by the terminal device 250.

The process 700 has been described by taking a PDU Set as an example of the set of data packets. Alternatively, in some embodiments, the set of data packets may comprise a data burst. The data burst may comprise one or more PDU Sets. The process 700 may be applicable to the embodiments where the set of data packets may comprise a data burst.

In embodiments where MN terminated split bearer is used in NR-DC, the first network device 210 may be implemented as MN and the second network device 220 may be implemented as SN.

In such embodiments, the information about the transmission status may comprise the first indication. The first indication may indicate whether the data burst has been transmitted to the terminal device 250 successfully in SCG.

In embodiments where SN terminated split bearer is used in NR-DC, the first network device 210 may be implemented as SN and the second network device 220 may be implemented as MN. In such embodiments, the first indication may indicate whether the data burst has been transmitted to the terminal device 250 successfully in MCG.

In some embodiments, the first network device 210 may obtain information about a second size of the PDU Set from the third network device 230. The first network device 210 may determine a first size (for example, in bytes) of remaining PDUs in the PDU Set based on the second size of the PDU Set and a third size of PDUs in the PDU Set that have been transmitted to the terminal device 250 successfully by the first network device 210. For example, the first network device 210 may determine the first size after stopping data transmission to the terminal device 250. In such embodiments, the information about the transmission status may comprise the first size of remaining PDUs.

In some embodiments, the first network device 210 may send the information about the transmission status comprising the first size of remaining PDUs in an SN Status Transfer message. Alternatively, the first network device 210 may send the information about the transmission status comprising the first size of remaining PDUs in a control signaling which is different from the SN Status Transfer message.

Alternatively, in some embodiments, the information about the transmission status may comprise: the second size of the PDU Set, and the third size of PDUs in the PDU Set that have been transmitted to the terminal device 250 successfully by the first network device 210. Upon receiving the information about the transmission status, the second network device 220 may determine the first size based on the second size and the third size.

In some embodiments, the first network device 210 may forward, to the second network device 220, PDUs in the PDU Set that have not been transmitted to the terminal device 250 successfully. The second network device 220 may receive, from the third network device 230, fresh PDUs in the PDU Set that have not been transmitted to the first network device 210. In turn, the second network device 220 may complete transmission of the PDU Set according to the first size of remaining PDUs.

In some embodiments, if a size of PDUs in the PDU Set that have not been transmitted to the terminal device 250 successfully (and fresh PDUs if any) is smaller than the first size of remaining PDUs, the second network device 220 may treat the PDU Set is transmitted incompletely and may trigger to discard the PDU Set accordingly.

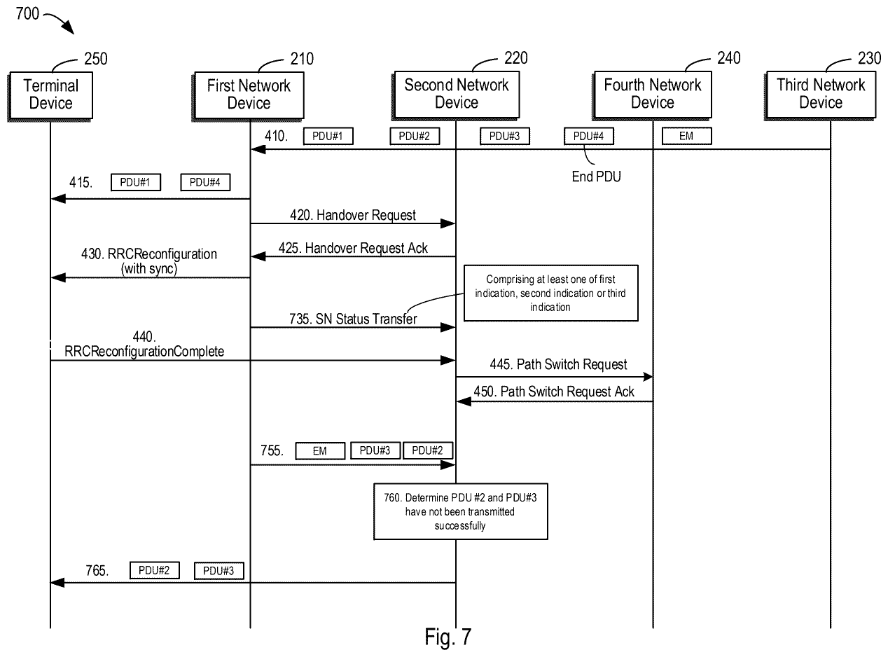

In some embodiments, the first network device 210 may determine that a timer associated with discard of the PDU Set expires before an End PDU in the PDU set is forwarded to the second network device 220. In turn, the first network device 210 may transmit, to the second network device 220, an indication indicating that the PDU set is to be discarded. Upon receiving the indication, the second network device 220 may discard all buffering PDUs in the PDU set. This will be described with reference to FIG. 8.

FIG. 8 illustrates a signaling chart illustrating an example process 800 for communications in accordance with some embodiments of the present disclosure. The process 800 may be considered an example implementation of the process 300. For the purpose of discussion, the process 800 will be described with reference to FIG. 2. The process 800 may involve the first network device 210, the second network device 220, the third network device 230, the fourth network device 240 and the terminal device 250. The process 800 may be described by taking a PDU Set as an example of the set of data packets.

Actions 420, 425, 430, 435, 440, 445 and 450 in the process 800 are the same as those in the process 400. Thus, details of these actions are omitted for brevity.

Actions 810, 815, 855, 860 and 865 in the process 800 are different from actions 410, 415, 455, 460 and 465 in the process 400. In addition, actions 812 and 852 in the process 800 are newly added.

Specifically, a PDU Set comprises PDU #1, PDU #2, PDU #3 and PDU #4. The first network device 210 receives 810, from the third network device 230, PDU #1, PDU #2 and PDU #3 in the PDU Set. PDU #4 is an End PDU in the PDU Set. A GTP-U extension header of PDCP SDU associated with PDU #4 may comprise an indication of End PDU which indicates that PDU #4 is the last PDU in the PDU Set.

Upon receiving PDU #1, the first network device 210 starts 812 a timer associated with discard of the PDU set. For example, the timer may comprise a PDCP discard timer of the PDU Set.

The first network device 210 transmits 815 PDU #1 to the terminal device 250 successfully.

However, the first network device 210 has transmitted PDU #2 and PDU #3 to the terminal device 250 but has not received positive acknowledgement from the terminal device 250. In other words, PDU #2 and PDU #3 have not been transmitted to the terminal device 250 successfully by the first network device 210.

During the handover procedure, the first network device 210 receives 852 PDU #4 (i.e., End PDU) and an EM packet from the third network device 230.

The first network device 210 forwards 855 PDU #2 and PDU #3 to the second network device 220.

The first network device 210 determines 860 that the timer expires before the End PDU (i.e., PDU #4) in the PDU set is forwarded to the second network device 220.

In some embodiments, expiry of the timer associated with discard of the PDU set may mean that PDCP discard timer of any PDU in the PDU Set expires.

Based on the determination, the first network device 210 transmits 865, to the second network device 220, an indication indicating that the PDU Set is to be discarded. For brevity, “the indication indicating that the PDU Set is to be discarded” is also referred to as a PDU Set Discard Indication.

In some embodiments, the PDU Set Discard Indication may comprise a sequence number of the PDU Set to be discarded.

In some embodiments, the PDU Set Discard Indication may be comprised either in the GTP-U extension header (such as a RAN container) or in a control plane signaling (such as in an Xn-AP message).

Upon receiving the PDU Set Discard Indication, the second network device 220 may discard all buffering PDUs in the PDU set identified by the sequence number.

In some embodiments, the information about the transmission status may comprise information about remaining time of a timer associated with discard of the PDU set.

In some embodiments, the information about the remaining time of the timer may be comprised either in the GTP-U extension header (such as a RAN container) or in a control plane signaling (such as in an Xn-AP message).

In some embodiments, the information about the remaining time of the timer may comprise the remaining time of the timer.

In some embodiments, the information about the remaining time of the timer may comprise a duration of the timer and elapsed time of the timer. The second network device 220 may determine the remaining time of the timer based on duration of the timer and the elapsed time of the timer.

In some embodiments, if the remaining time runs out, the second network device 220 may discard all buffering PDUs in the PDU Set.

In some embodiments, a PDU Set based path switch may be performed by the third network device 230. If there is ongoing data transmission of a PDU Set, the third network device 230 may send, to the first network device 210, one or more EM packets only after the End PDU of the PDU Set.

Currently, the second network device 220 sends a Path Switch Request message to the fourth network device 240 to trigger the third network device 230 to switch the downlink (DL) data path towards the second network device 220. The third network device 230 switches the DL data path towards the second network device 220. The third network device 230 sends one or more EM packets on the old path to the first network device 210 per PDU session or per tunnel (TNL). Then, the third network device 230 can release any U-plane/TNL resources towards the first network device 210.

In some embodiments, the third network device 230 may switch the DL data path only after complete transmission of a PDU Set. It means that the third network device 230 switches the DL data path from the old path (i.e., GTP-U tunnel between the third network device 230 and the first network device 210 for DL data transmission) to new path (i.e., GTP-U tunnel between the third network device 230 and the second network device 220 for DL data transmission) only when all PDUs of a PDU set have been transmitted to the first network device 210.

In case of handover, SMF may indicate the third network device 230 to switch DL data path and provide an indication to the third network device 230 to send one or more EM packets on the old data path. If there is ongoing data transmission of a PDU Set, the third network device 230 sends, to the first network device 210, the one or more EM packets only after the End PDU of the PDU Set. The third network device 230 starts to transmit PDUs of a new PDU set to the second network device 220 via the new path.

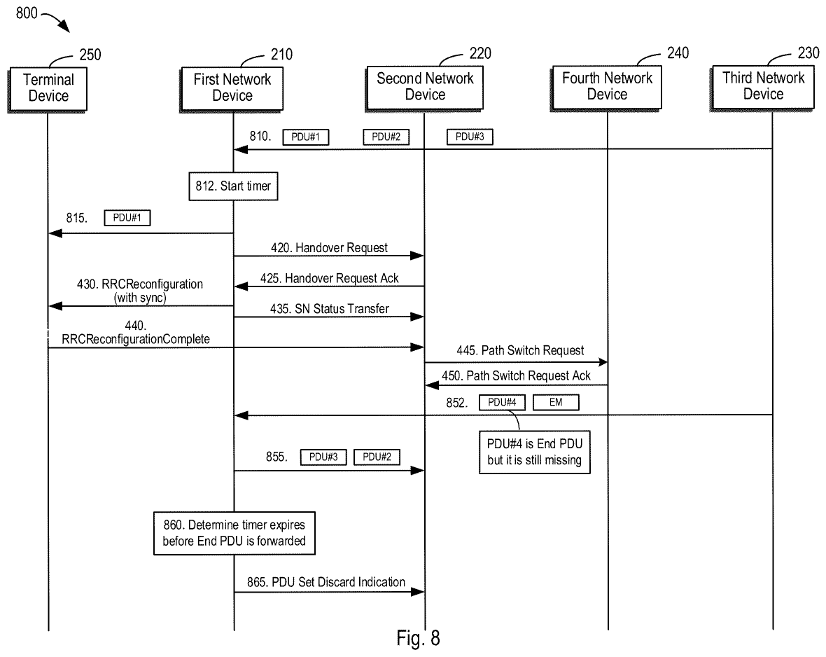

FIG. 9 illustrates a flowchart of an example method implemented at a network device in accordance with some embodiments of the present disclosure. For the purpose of discussion, the method 900 will be described from the perspective of the first network device 210 with reference to FIG. 2.

At block 910, the first network device 210 receives, from the third network device 230, at least one data packet in a set of data packets.

At block 920, the first network device 210 forwards, to the second network device 220, a subset of the at least one data packet.

At block 930, the first network device 210 transmits, to the second network device 220, information about a transmission status of the set of data packets from the first network device 210 to the terminal device 250.

In some embodiments, the information about the transmission status may comprise an indication of a last data packet that has not been transmitted to the terminal device 250 successfully by the first network device 210.

In some embodiments, the indication of the last data packet may comprise an ending indication for the set of data packets.

In some embodiments, the indication of the last data packet may comprise a last sequence number for the last data packet, the last sequence number is higher than sequence numbers for other data packets in the subset.

In some embodiments, the subset may comprise an end data packet in the set of data packets, and the information about the transmission status may comprise an indication of the end data packet.

In some embodiments, the subset further may comprise all the data packets in the set of data packets, and the information about the transmission status may comprise an indication of an end data packet in the set of data packets.

In some embodiments, the information about the transmission status may comprise at least one of the following:
a first indication indicating whether the set of data packets has been transmitted to the terminal device 250 successfully by the first network device 210,
a second indication of transmission statuses of the data packets in the set, or
a third indication of a transmission status of an end data packet in the set.

In some embodiments, the third indication may comprise one of the following:
a fourth indication indicating whether the end data packet has been transmitted to the terminal device 250 successfully by the first network device 210,
a fifth indication indicating that the end data packet has been received from a third network device 230 but has not been transmitted to the terminal device 250 by the first network device 210, or
a sixth indication indicating that the end data packet has not been received from the third network device 230.

In some embodiments, the set of data packets may comprise a PDU set.

In some embodiments, the method 900 further comprising: determining a first size of remaining PDUs in the PDU set based on a second size of the PDU set and a third size of PDUs in the PDU set that have been transmitted to the terminal device 250 successfully by the first network device 210.

In some embodiments, the information about the transmission status may comprise the first size of remaining PDUs.

In some embodiments, the information about the transmission status may comprise: a second size of the PDU set, and a third size of PDUs in the PDU set that have been transmitted to the terminal device 250 successfully by the first network device 210.

In some embodiments, the method 900 further comprising: determining that a timer associated with discard of the PDU set expires before an end PDU in the PDU set is forwarded to the second network device 220; and based on the determination, transmitting, to the second network device 220, an indication indicating that the PDU set is to be discarded.

In some embodiments, the information about the transmission status may comprise information about remaining time of a timer associated with discard of the PDU set.

In some embodiments, the set of data packets may comprise a data burst.

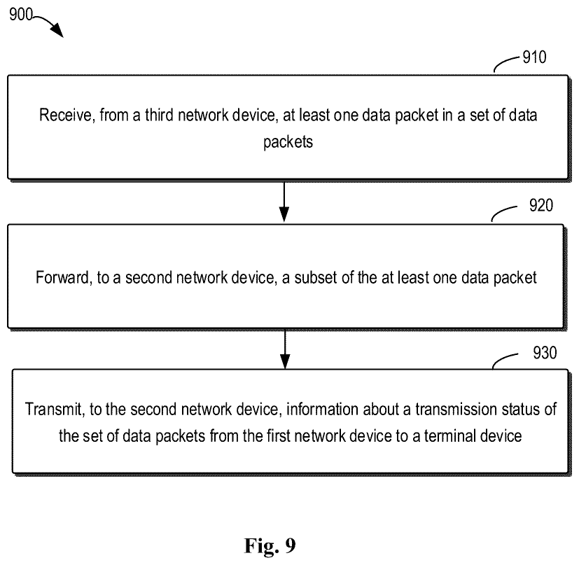

FIG. 10 illustrates a flowchart of an example method implemented at a network device in accordance with some embodiments of the present disclosure. For the purpose of discussion, the method 1000 will be described from the perspective of the second network device 220 with reference to FIG. 2.

At block 1010, the second network device 220 receives, from the first network device 210, a subset of a set of data packets.

At block 1020, the second network device 220 receives, from the first network device 210, information about a transmission status of the set of data packets from the first network device 210 to a terminal device 250.

At block 1030, the second network device 220 transmits, to the terminal device 250, at least one data packet in the subset based on the information about the transmission status.

In some embodiments, the information about the transmission status may comprise an indication of a last data packet that has not been transmitted to the terminal device 250 successfully by the first network device 210.

In some embodiments, the indication of the last data packet may comprise an end indication for the set of data packets.

In some embodiments, the indication of the last data packet may comprise a last sequence number for the last data packet, the last sequence number is higher than sequence numbers for other data packets in the subset.

In some embodiments, the subset may comprise an end data packet in the set of data packets, and the information about the transmission status may comprise an indication of the end data packet.

In some embodiments, the subset may comprise all the data packets in the set of data packets, and the information about the transmission status may comprise an indication of an end data packet in the set of data packets.

In some embodiments, the method 1000 further comprises: receiving, from the terminal device 250, an indication of receiving statuses of the data packets in the set of data packets. In such embodiments, transmitting the at least one data packet in the subset comprises: transmitting the at least one data packet based on the indication of receiving statuses.

In some embodiments, the method 1000 further comprises: receiving, from the terminal device 250, an indication of a receiving status of the set of data packets. In such embodiments, transmitting the at least one data packet in the subset comprises: transmitting the at least one data packet based on the indication of the receiving status.

In some embodiments, the information about the transmission status may comprise at least one of the following:
a first indication indicating whether the set of data packets has been transmitted to the terminal device 250 successfully by the first network device 210,
a second indication of transmission statuses of the data packets in the set, or
a third indication of a transmission status of an end data packet in the set.

In some embodiments, the third indication may comprise one of the following:
a fourth indication indicating whether the end data packet has been transmitted to the terminal device 250 successfully by the first network device 210,
a fifth indication indicating that the end data packet has been received from a third network device 230 but has not been transmitted to the terminal device 250 by the first network device 210, or
a sixth indication indicating that the end data packet has not been received from the third network device 230.

In some embodiments, the set of data packets may comprise a PDU set.

In some embodiments, the information about the transmission status may comprise a first size of remaining PDUs in the PDU set. The first size of remaining PDUs is determined based on a second size of the PDU set and a third size of PDUs in the PDU set that have been transmitted to the terminal device 250 successfully by the first network device 210.

In some embodiments, the information about the transmission status may comprise: a second size of the PDU set, and a third size of PDUs in the PDU set that have been transmitted to the terminal device 250 successfully by the first network device 210. In such embodiments, the method 1000 further comprises: determining a first size of remaining PDUs in the PDU set based on the second size and the third size.

In some embodiments, the method 1000 further comprises: receiving, from the first network device 210, an indication indicating that the PDU set is to be discarded.

In some embodiments, the method 1000 further comprises: discarding all PDUs in the PDU set based on the indication.

In some embodiments, the information about the transmission status may comprise information about remaining time of a timer associated with discard of the PDU set.

In some embodiments, the method 1000 further comprises: based on determining that the remaining time runs out, discarding all PDUs in the PDU set.

In some embodiments, the set of data packets may comprise a data burst.

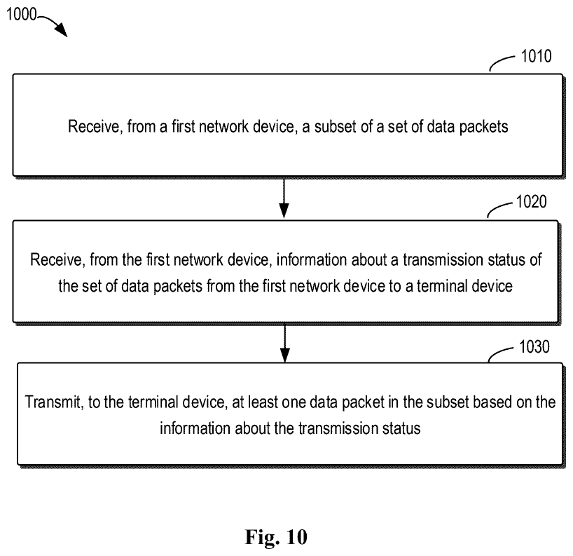

FIG. 11 illustrates a flowchart of an example method implemented at a terminal device in accordance with some embodiments of the present disclosure. For the purpose of discussion, the method 1100 will be described from the perspective of the terminal device 250 with reference to FIG. 2.

At block 1110, the terminal device 250 determines a receiving status of a set of data packets.

At block 1120, the terminal device 250 transmits, to the second network device 220, an indication of the receiving status of the set of data packets.

In some embodiments, the method 1100 further comprises: determining receiving statuses of the data packets in the set of data packets; and transmitting, to the second network device 220, an indication of the receiving statuses of the data packets.

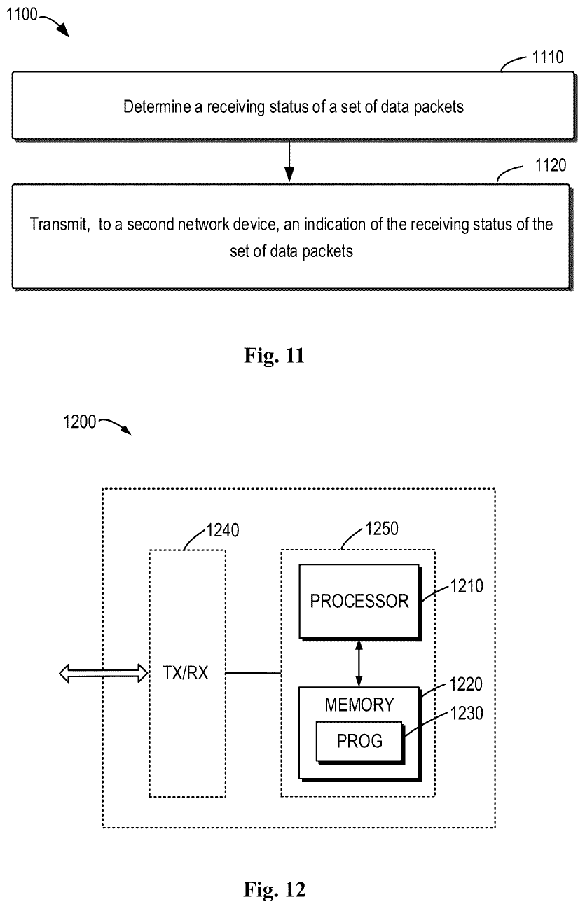

FIG. 12 illustrates a simplified block diagram of an apparatus 1200 that is suitable for implementing embodiments of the present disclosure. The apparatus 1200 can be considered as a further example implementation of the first network device 210, the second network device 220, or the terminal device 250 as shown in FIG. 2. Accordingly, the apparatus 1200 can be implemented at or as at least a part of the first network device 210, the second network device 220, or the terminal device 250.

As shown, the apparatus 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 1210 stores at least a part of a program 1230. The TX/RX 1240 is for bidirectional communications. The TX/RX 1240 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1230 is assumed to include program instructions that, when executed by the associated processor 1210, enable the apparatus 1200 to operate in accordance with the embodiments of the present disclosure, as discussed herein with reference to FIGS. 1 to 11. The embodiments herein may be implemented by computer software executable by the processor 1210 of the apparatus 1200, or by hardware, or by a combination of software and hardware. The processor 1210 may be configured to implement various embodiments of the present disclosure. Furthermore, a combination of the processor 1210 and memory 1220 may form processing means 1250 adapted to implement various embodiments of the present disclosure.

The memory 1220 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1220 is shown in the apparatus 1200, there may be several physically distinct memory modules in the apparatus 1200. The processor 1210 may be of any type suitable to the local technical network, and may include one or more of general purpose computers, special purpose computers, microprocessors, digital signal processors (DSPs) and processors based on multicore processor architecture, as non-limiting examples. The apparatus 1200 may have multiple processors, such as an application specific integrated circuit chip that is slaved in time to a clock which synchronizes the main processor.

In summary, embodiments of the present disclosure may provide the following solutions.

Clause 1. A first network device, comprising: a processor; and a transceiver coupled to the processor, wherein the processor is configured to: receive, via the transceiver from a third network device, at least one data packet in a set of data packets; forward, via the transceiver to a second network device, a subset of the at least one data packet; and transmit, via the transceiver to the second network device information about a transmission status of the set of data packets from the first network device to a terminal device.

Clause 2. The first network device of Clause 1, wherein the information about the transmission status comprises an indication of a last data packet that has not been transmitted to the terminal device successfully by the first network device.

Clause 3. The first network device of Clause 2, wherein the indication of the last data packet comprises an ending indication for the set of data packets.

Clause 4. The first network device of Clause 2, wherein the indication of the last data packet comprises a last sequence number for the last data packet, the last sequence number is higher than sequence numbers for other data packets in the subset.

Clause 5. The first network device of Clause 1, wherein the subset comprises an end data packet in the set of data packets, and the information about the transmission status comprises an indication of the end data packet.

Clause 6. The first network device of Clause 1, wherein the subset further comprises all the data packets in the set of data packets, and the information about the transmission status comprises an indication of an end data packet in the set of data packets.

Clause 7. The first network device of Clause 1, wherein the information about the transmission status comprises at least one of the following: a first indication indicating whether the set of data packets has been transmitted to the terminal device successfully by the first network device, a second indication of transmission statuses of the data packets in the set, or a third indication of a transmission status of an end data packet in the set.

Clause 8. The first network device of Clause 7, wherein the third indication comprises one of the following: a fourth indication indicating whether the end data packet has been transmitted to the terminal device successfully by the first network device, a fifth indication indicating that the end data packet has been received from a third network device but has not been transmitted to the terminal device by the first network device, or a sixth indication indicating that the end data packet has not been received from the third network device.

Clause 9. The first network device of Clause 1, wherein the set of data packets comprises a protocol data unit (PDU) set.

Clause 10. The first network device of Clause 9, wherein the processor is further configured to: determine a first size of remaining PDUs in the PDU set based on a second size of the PDU set and a third size of PDUs in the PDU set that have been transmitted to the terminal device successfully by the first network device; and wherein the information about the transmission status comprises the first size of remaining PDUs.

Clause 11. The first network device of Clause 9, wherein the information about the transmission status comprises: a second size of the PDU set, and a third size of PDUs in the PDU set that have been transmitted to the terminal device successfully by the first network device.

Clause 12. The first network device of Clause 9, wherein the processor is further configured to: determine that a timer associated with discard of the PDU set expires before an end PDU in the PDU set is forwarded to the second network device; and based on the determination, transmit, via the transceiver to the second network device, an indication indicating that the PDU set is to be discarded.

Clause 13. The first network device of Clause 9, wherein the information about the transmission status comprises information about remaining time of a timer associated with discard of the PDU set.

Clause 14. The first network device of Clause 1, wherein the set of data packets comprises a data burst.

Clause 15. A second network device, comprising: a processor; and a transceiver coupled to the processor, wherein the processor is configured to: receive, via the transceiver from a first network device, a subset of a set of data packets; receive, via the transceiver from the first network device, information about a transmission status of the set of data packets from the first network device to a terminal device; and transmit, via the transceiver to the terminal device, at least one data packet in the subset based on the information about the transmission status.

Clause 16. The second network device of Clause 15, wherein the information about the transmission status comprises an indication of a last data packet that has not been transmitted to the terminal device successfully by the first network device.

Clause 17. The second network device of Clause 16, wherein the indication of the last data packet comprises an end indication for the set of data packets.

Clause 18. The second network device of Clause 16, wherein the indication of the last data packet comprises a last sequence number for the last data packet, the last sequence number is higher than sequence numbers for other data packets in the subset.

Clause 19. The second network device of Clause 15, wherein the subset comprises an end data packet in the set of data packets, and the information about the transmission status comprises an indication of the end data packet.

Clause 20. The second network device of Clause 15, wherein the subset comprises all the data packets in the set of data packets, and the information about the transmission status comprises an indication of an end data packet in the set of data packets.

Clause 21. The second network device of Clause 19 or 20, wherein the processor is further configured to: receive, from the terminal device, an indication of receiving statuses of the data packets in the set of data packets; and wherein the processor is configured to transmit, via the transceiver, the at least one data packet in the subset by: transmitting the at least one data packet based on the indication of receiving statuses.

Clause 22. The second network device of Clause 20, wherein the processor is further configured to: receive, from the terminal device, an indication of a receiving status of the set of data packets; and wherein the processor is configured to transmit, via the transceiver, the at least one data packet in the subset by: transmitting the at least one data packet based on the indication of the receiving status.

Clause 23. The second network device of Clause 15, wherein the information about the transmission status comprises at least one of the following: a first indication indicating whether the set of data packets has been transmitted to the terminal device successfully by the first network device, a second indication of transmission statuses of the data packets in the set, or a third indication of a transmission status of an end data packet in the set.

Clause 24. The second network device of Clause 23, wherein the third indication comprises one of the following: a fourth indication indicating whether the end data packet has been transmitted to the terminal device successfully by the first network device, a fifth indication indicating that the end data packet has been received from a third network device but has not been transmitted to the terminal device by the first network device, or a sixth indication indicating that the end data packet has not been received from the third network device.

Clause 25. The second network device of Clause 15, wherein the set of data packets comprises a protocol data unit (PDU) set.

Clause 26. The second network device of Clause 25, wherein the information about the transmission status comprises a first size of remaining PDUs in the PDU set, the first size of remaining PDUs is determined based on a second size of the PDU set and a third size of PDUs in the PDU set that have been transmitted to the terminal device successfully by the first network device.

Clause 27. The second network device of Clause 25, wherein the information about the transmission status comprises: a second size of the PDU set, and a third size of PDUs in the PDU set that have been transmitted to the terminal device successfully by the first network device; and wherein the processor is further configured to: determine a first size of remaining PDUs in the PDU set based on the second size and the third size.

Clause 28. The second network device of Clause 25, wherein the processor is further configured to: receive, via the transceiver from the first network device, an indication indicating that the PDU set is to be discarded.

Clause 29. The second network device of Clause 28, wherein the processor is further configured to: discard all PDUs in the PDU set based on the indication.

Clause 30. The second network device of Clause 25, wherein the information about the transmission status comprises information about remaining time of a timer associated with discard of the PDU set.

Clause 31. The second network device of Clause 30, wherein the processor is further configured to: based on determining that the remaining time runs out, discard all PDUs in the PDU set.

Clause 32. The second network device of Clause 15, wherein the set of data packets comprises a data burst.

Clause 33. A terminal device, comprising: a processor; and a transceiver coupled to the processor, wherein the processor is configured to: determine a receiving status of a set of data packets; and transmit, via the transceiver to a second network device, an indication of the receiving status of the set of data packets.

Clause 34. The terminal device of Clause 33, wherein the processor is further configured to: determine receiving statuses of the data packets in the set of data packets; and transmit, via the transceiver to the second network device, an indication of the receiving statuses of the data packets.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first network device for wireless communication, comprising:
at least one memory; and
at least one processor coupled with the at least one memory and configured to cause the first network device to:
receive, from a third network device, at least one data packet in a set of data packets;
forward, to a second network device, a subset of the at least one data packet; and
transmit, to the second network device, information about a transmission status of the set of data packets from the first network device to a terminal device.

2. The first network device of claim 1, wherein the information about the transmission status comprises an indication of a last data packet that has not been transmitted successfully to the terminal device by the first network device.

3. The first network device of claim 2, wherein the indication of the last data packet comprises an ending indication for the set of data packets.

4. The first network device of claim 1, wherein the subset of the at least one data packet comprises an end data packet in the set of data packets, and wherein the information about the transmission status comprises an indication of the end data packet.

5. The first network device of claim 1, wherein the subset of the at least one data packet further comprises all data packets in the set of data packets, and wherein the information about the transmission status comprises an indication of an end data packet in the set of data packets.

6. The first network device of claim 1, wherein the information about the transmission status comprises:
a first indication indicating whether the set of data packets has been transmitted successfully to the terminal device by the first network device,
a second indication of transmission statuses of the data packets in the set of data packets, or
a third indication of a transmission status of an end data packet in the set of data packets.

7. The first network device of claim 6, wherein the third indication:
a fourth indication indicating whether the end data packet has been transmitted successfully to the terminal device by the first network device,
a fifth indication indicating that the end data packet has been received from a third network device but has not been transmitted to the terminal device by the first network device, or
a sixth indication indicating that the end data packet has not been received from the third network device.

8. The first network device of claim 1, wherein the set of data packets comprises a protocol data unit (PDU) set.

9. The first network device of claim 8, wherein the at least one processor is further configured to cause the first network device to:
determine a first size of remaining PDUs in the PDU set based on a second size of the PDU set and a third size of PDUs in the PDU set that have been transmitted successfully to the terminal device by the first network device;
wherein the information about the transmission status comprises the first size of the remaining PDUs.

10. The first network device of claim 8, wherein the information about the transmission status comprises:
a second size of the PDU set; and
a third size of PDUs in the PDU set that have been transmitted to the terminal device successfully by the first network device.

11. The first network device of claim 8, wherein the at least one processor is further configured to cause the first network device to:
determine that a timer associated with a discard of the PDU set expires before an end PDU in the PDU set is forwarded to the second network device; and
transmit, to the second network device and based on the determination, an indication indicating that the PDU set is to be discarded.

12. The first network device of claim 8, wherein the information about the transmission status comprises information about a remaining time of a timer associated with a discard of the PDU set.

13. The first network device of claim 1, wherein the set of data packets comprises a data burst.

14. A terminal device for wireless communication, comprising:
at least one memory; and
at least one processor coupled with the at least one memory and configured to cause the terminal device to:
determine a receiving status of a set of data packets; and
transmit, to a second network device, an indication of the receiving status of the set of data packets.

15. The terminal device of claim 14, wherein the at least one processor is further configured to cause the terminal device to:
determine receiving statuses of data packets in the set of data packets; and
transmit, to the second network device, an indication of the receiving statuses of the data packets in the set of data packets.

16. A method performed by a first network device, the method comprising:
receiving, from a third network device, at least one data packet in a set of data packets;
forwarding, to a second network device, a subset of the at least one data packet; and
transmitting, to the second network device, information about a transmission status of the set of data packets from the first network device to a terminal device.

17. The method of claim 16, wherein the information about the transmission status comprises an indication of a last data packet that has not been transmitted successfully to the terminal device by the first network device.

18. The method of claim 16, wherein the information about the transmission status comprises:
a first indication indicating whether the set of data packets has been transmitted successfully to the terminal device by the first network device,
a second indication of transmission statuses of the data packets in the set of data packets, or
a third indication of a transmission status of an end data packet in the set of data packets.

19. A method performed by a terminal device, the method comprising:
determining a receiving status of a set of data packets; and
transmitting, to a second network device, an indication of the receiving status of the set of data packets.

20. The method of claim 19, further comprising:
determining receiving statuses of data packets in the set of data packets; and
transmitting, to the second network device, an indication of the receiving statuses of the data packets in the set of data packets.
